(19) United States
(12) Patent Application Publication
(10) Pub. No.: US 2016/0019559 A1
(43) Pub. Date: Jan. 21, 2016

(54) TASTE PROFILE AND BEVERAGE DISTRIBUTION METHOD

(71) Applicant: Angels' Take Inc., BROOKLYN, NY (US)

(72) Inventor: JEFFREY BORACK, BROOKLYN, NY (US)

(21) Appl. No.: 14/800,102

(22) Filed: Jul. 15, 2015

Related U.S. Application Data
(60) Provisional application No. 62/024,648, filed on Jul. 15, 2014.

(51) Int. Cl. G06Q 30/02

(52) U.S. Cl. CPC G06Q 30/0201

(57) ABSTRACT

Disclosed is a method that includes providing at least one sample of a beverage or beverage source ingredient in a package to a subscriber, where an identity of the beverage or beverage source ingredient is not provided but an identifying characteristic is provided that does not provide the subscriber with the identity. The method includes providing a computer application, wherein the application performs the steps of receiving the identifying characteristic, prompting the user to enter information about the user's experience tasting the beverage or a resulting beverage that derives from the beverage or beverage source ingredient, receiving information from the user about the user's experience tasting the beverage or the resulting beverage, and comparing the information about the user's experience tasting the beverage or the resulting beverage with the data pertaining to an expert's experience tasting the beverage or the resulting beverage.

### RELATED APPLICATIONS

This application is a nonprovisional application of and claims priority to U.S. Provisional Patent Application No. 62/024,648 filed Jul. 15, 2014, entitled “TASTE PROFILE METHOD,” which is incorporated herein by reference to the extent that it is not inconsistent with the present disclosure.

### FIELD OF TECHNOLOGY

The subject matter disclosed herein relates generally to a method of determining a user's taste and a method of distributing beverages. More particularly, the subject matter relates to a method of generating a user's taste profile by sending product sample and capturing data on a user's taste and preferences through an online experience.

### BACKGROUND

The coffee industry has become prolific in the past decade or more. At present over 2.25 billion cups of coffee are consumed in the world every day. It has been estimated that coffee exporting alone is a $20 billion dollar industry. In the U.S., more than 150 million Americans drink coffee on a daily basis. Coffee is cultivated from various different countries and regions throughout the world and exported throughout the world. Coffee has distinct flavors depending on where the beans are grown, and various other factors relating to the roasting and growing of the beans. The average consumer is capable of discerning one coffee from another at a very basic level (i.e., Dunkin Donuts® compared to Starbucks®). However, despite the inquisitive nature of many consumers, the knowledge and taste of the average consumer does not extend beyond a very basic understanding of coffee.

Therefore, an online experience for helping determine a user's taste and teaching the user about coffee would be well received in the art. Further, the methods and online experience taught herein may be applicable to other beverages besides coffee, such as whiskey, bourbon, wine, tea, vodka, gin, rum, and tequila. Moreover, the methods and online experience taught herein may be applicable to non-beverage products such as tobacco (or other smoke-able products), food (chocolate, cheese, etc.), or the like.

### SUMMARY

According to a first described aspect, a method comprises: providing at least one sample of a beverage or beverage source ingredient in a package to a subscriber, wherein an identity of the beverage or beverage source ingredient is not provided, wherein the at least one sample includes an identifying characteristic, wherein the identifying characteristic does not provide any information about the identity of the beverage or beverage source ingredient to the subscriber; and providing a computer application, wherein the application performs the steps of: receiving the identifying characteristic; prompting the user to enter information about the user's experience tasting the beverage or a resulting beverage that derives from the beverage or beverage source ingredient; receiving information from the user about the user's experience tasting the beverage or the resulting beverage; determining, using the identifying characteristic, the identity of the beverage or beverage source ingredient; receiving information from an expert regarding the expert's experience tasting the beverage or the resulting beverage; storing data pertaining to the expert's experience tasting the beverage or the resulting beverage; comparing the information about the user's experience tasting the beverage or the resulting beverage with the data pertaining to the expert's experience tasting the beverage or the resulting beverage; and displaying a comparison of the user's experience tasting the beverage or the resulting beverage with the expert's experience tasting the beverage or the resulting beverage.

According to a second described aspect, a method comprises: providing at least one sample of a beverage or beverage source ingredient in a package to a subscriber, wherein an identity of the beverage or beverage source ingredient is not provided, wherein the at least one sample includes an identifying characteristic, wherein the identifying characteristic does not provide any information about the identity of the beverage or beverage source ingredient to the subscriber; and providing a computer application, wherein the application performs the steps of: receiving the identifying characteristic; determining, using the identifying characteristic, the identity of the beverage or beverage source ingredient; prompting the user to enter information about the user's experience tasting the beverage or a resulting beverage that derives from the beverage or beverage source ingredient; receiving information from the user about the user's experience tasting the beverage or the resulting beverage; storing, in a database, data pertaining to other users tasting the beverage or the resulting beverage; aggregating the data pertaining to the other users tasting the beverage or the resulting beverage; comparing the information about the user's experience tasting the beverage or the resulting beverage with the aggregated data pertaining to the other users tasting the beverage or the resulting beverage; and displaying a comparison of the user's experience tasting the beverage or the resulting beverage with the aggregated data pertaining to the other users experience tasting the beverage or the resulting beverage.

According to a third described aspect, a method comprises: providing a first sample of a first beverage or first beverage source ingredient in a first package and a second sample of a second beverage or second beverage source ingredient in a second package to a subscriber, wherein the identity of the first beverage or first beverage source ingredient and the second beverage or second beverage source ingredient are not provided, wherein the first sample includes a first identifying characteristic, wherein the first identifying characteristic does not provide any information about the identity of the first beverage or first beverage source ingredient to the subscriber, wherein the second sample includes a second identifying characteristic, wherein the second identifying characteristic does not provide any information about the identity of the second beverage or second beverage source ingredient to the subscriber; and providing a computer application, wherein the application performs the steps of: receiving the first identifying characteristic; determining, using the first identifying characteristic, the identity of the first beverage or first beverage source ingredient; prompting the user to enter information about the user's experience tasting a first characteristic of the first beverage or a first resulting beverage derived from the first beverage source ingredient; receiving information from the user about the user's experience tasting the first characteristic of the first beverage or the first resulting beverage; storing data pertaining to a first expert's experience tasting the first characteristic of the first beverage or the first resulting beverage; receiving the second identifying characteristic; determining, using the second identifying characteristic, the identity of the second beverage or second beverage source ingredient; prompting the user to enter information about the user's experience tasting the first characteristic of the second beverage or a second resulting beverage derived from the second beverage source ingredient; receiving information from the user about the user's experience tasting the first characteristic of the second beverage or the second resulting beverage; and storing data pertaining to the first expert's experience or a second expert's experience tasting the first characteristic of the second beverage or the second resulting beverage, wherein the first expert's experience tasting the first characteristic of the first beverage or the first resulting beverage has a discernible difference compared with the first or second expert's experience tasting the first characteristic of the second beverage or the second resulting beverage.

### BRIEF DESCRIPTION OF THE DRAWINGS

The subject matter disclosed herein is distinctly claimed in the claims at the conclusion of the specification. The foregoing and other features and advantages are apparent from the following detailed description taken in conjunction with the accompanying drawings in which:

FIG. 1 depicts a welcome interface of a taste profile application in accordance with one embodiment;

FIG. 2 depicts a log-in interface of the taste profile application of FIG. 1 in accordance with one embodiment;

FIG. 3 depicts a coffee-entering interface of the taste profile application of FIGS. 1-2 in accordance with another embodiment;

FIG. 4 depicts a first step of generating a user's taste profile in the taste profile application of FIGS. 1-3 in accordance with one embodiment;

FIG. 5 depicts a second step of generating a user's taste profile in the taste profile application of FIGS. 1-4 according to one embodiment;

FIG. 6 depicts a third step of generating a user's taste profile in the taste profile application of FIGS. 1-5 according to one embodiment;

FIG. 7 depicts a fourth step of generating a user's taste profile in the taste profile application of FIGS. 1-6 according to one embodiment;

FIG. 8 depicts a fifth step in generating a user's taste profile in the taste profile application of FIGS. 1-7 in accordance with one embodiment;

FIG. 9 depicts a sixth step in generating a user's taste profile in the taste profile application of FIGS. 1-8 in accordance with one embodiment;

FIG. 10 depicts a seventh step in generating a user's taste profile in the taste profile application of FIGS. 1-9 in accordance with one embodiment;

FIG. 11 depicts a eighth step in generating a user's taste profile in the taste profile application of FIGS. 1-10 in accordance with one embodiment;

FIG. 12 depicts a tour function of the taste profile application of FIGS. 1-11 in accordance with one embodiment;

FIG. 13 depicts a step of the tour function of FIG. 12 in accordance with one embodiment;

FIG. 14 depicts a summary page of a user's taste profile in the taste profile application of FIGS. 1-13 in accordance with one embodiment;

FIG. 15 depicts a second summary page in the taste profile application of FIGS. 1-15 that brings a user to additional content about the particularly beverage tasted in accordance with one embodiment;

FIG. 16 depicts an interface directing users to a website associated with an identity of the beverage tasted in accordance with one embodiment.

FIG. 17 depicts a first layer of a graphical user interface of the taste profile application of FIGS. 1-16 in accordance with one embodiment;

FIG. 18 depicts a second layer of a graphical user interface of the taste profile application of FIGS. 1-17 in accordance with one embodiment;

FIG. 19 depicts a third layer of a graphical user interface of the taste profile application of FIGS. 1-18 in accordance with one embodiment;

FIG. 20 depicts a fourth layer of a graphical user interface of the taste profile application of FIGS. 1-19 in accordance with one embodiment;

FIG. 21 depicts two correlation graphs charting the perception of value of two taste metrics in accordance with one embodiment; and

FIG. 22 depicts a computer system in accordance with one embodiment.

### DETAILED DESCRIPTION

A detailed description of the hereinafter described embodiments of the disclosed apparatus and method are presented herein by way of exemplification and not limitation with reference to the Figures.

Disclosed herein is an online experience for helping determine a user's taste and teaching the user about coffee. It should be understood that the methods and online experience described herein may be applicable to other beverages besides coffee, such as whiskey, bourbon, wine, tea, vodka, gin, rum, and tequila. Moreover, the methods and online experience taught herein may be applicable to non-beverage products such as cigars, cigarettes or tobacco (or other smoke-able products), food (chocolate, cheese, etc.), or the like.

The method may include a first step of providing at least one sample of a beverage or beverage source ingredient to a subscriber. Providing samples in accordance with embodiments described herein may be performed by a company, entity individual or the like that is paid, hired, or otherwise contracted to do so. Thus, a company may host an online marketplace, in one embodiment, where a subscriber signs up to have samples provided by the company for a monthly, yearly, or weekly fee. In other embodiments, the company may offer one time packages of samples. In other embodiments, the company may offer product available at other retail outlets unlike the packages of samples described herein. Still further, the company, entity or individual providing the samples may further be responsible for hosting, maintaining and providing the applications and other aspects of the methods described herein.

It should be understood that the word “beverage” may hereinafter mean any product that is already provided in a drinkable form. A “beverage source ingredient” may refer to a product that is provided in, for example, a non-liquid form that will later be converted into a beverage. For example, coffee beans (or ground coffee), tea leaves or tea bags may be considered “beverage source ingredients.” Once a beverage source ingredient has been turned into a beverage, the resulting beverage may be hereinafter referred to as a “resulting beverage.” Again, the “beverage” embodiment shown in the Figures and described throughout this description is described for exemplary purposes and that other contemplated embodiments may be directed toward edible, smoke-able or consumable products.

The step of providing the samples may be accomplished by sending the samples in a package. It should be understood that “package” hereafter means any container, parcel, packet, bottle, can, or the like. Any container configured to hold the respective product is contemplated. In one embodiment, several samples of different beverages or beverage source ingredients may be sent to a subscriber. The number of samples sent in any given period may be determined by the amount of money the subscriber is willing to pay. In other embodiments, samples may be sent at regular or irregular intervals.

The identity of the beverage or other product may not be provided to the subscriber at the time the samples are sent to the subscriber in a manner that is readily apparent to the subscriber. “Identity” hereinafter may refer to the maker of the beverage or other product, or to any identifying characteristic pertaining to the beverage or product, or to the beverage or product's source or creation. For example, in the case of coffee, the identity may refer to the roastmaster or company, along with the particular roast of coffee. For example, the identity may refer to a French roast coffee blend from a particular company or roastmaster. In the case of bourbon, for example, the identity may refer to the distiller, year, and/or batch of the bourbon. In the case of wine, the identity may refer to the vintner or winemaker, year, or varietal of the wine. In the case of beer, the identity may refer to the type or style of beer and/or the brewery or brewmaster. It should be understood that identity may refer to any identifying characteristic pertaining to the beverage or product's source or creation. For example, the identity may include information regarding an origin. In the case of coffee, the term origin may refer to the location where the beans that are in the particular coffee roast were grown. Similarly, in wine, origin may refer to the location where the grapes were grown. In other embodiments, the identity may be provided in a manner that is not readily apparent to a subscriber or user. For example, the identity may be provided in an enclosed envelope labeled “product information, do not open before tasting.” Thus, a deliberate decision may be required to be made on behalf of the subscriber or user in order to find out the identity of the beverage, beverage source ingredient or other product. Still further, in the case of wine, a bottle may be sent to a subscriber or user, and the bottle may be covered by a slip, or cover, hiding the identity or label of the wine. This cover may be intentionally removed by a subscriber or user at any point, such as after a blind tasting is conducted in conjunction with the application 10 described hereinbelow.

Despite not having information pertaining to the identity of the beverage or beverage source ingredient or other product, the at least one sample may include an identifying characteristic. The identifying characteristic may be an alphanumeric set of digits provided on the packaging. The identifying characteristic may be a mark on the package which can be captured by an image capture device located, for example, on a mobile communicator or phone. The identifying characteristic may be an RFID chip located within the package which integrates with a scanning mechanism located on a mobile communicator or phone. A bar code may also be an identifying characteristic. The identifying characteristic may also be an indicative characteristic. Any type of feature that is capable of marking the beverage, beverage source ingredient or other product, without overtly providing information to the subscriber as to the identity of the product is contemplated.

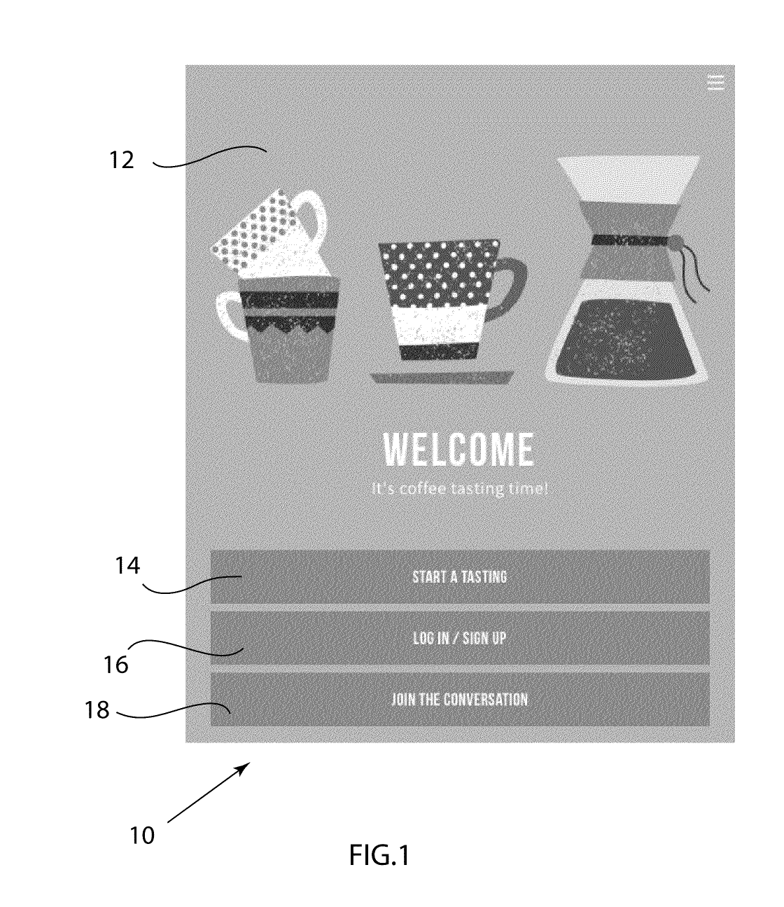

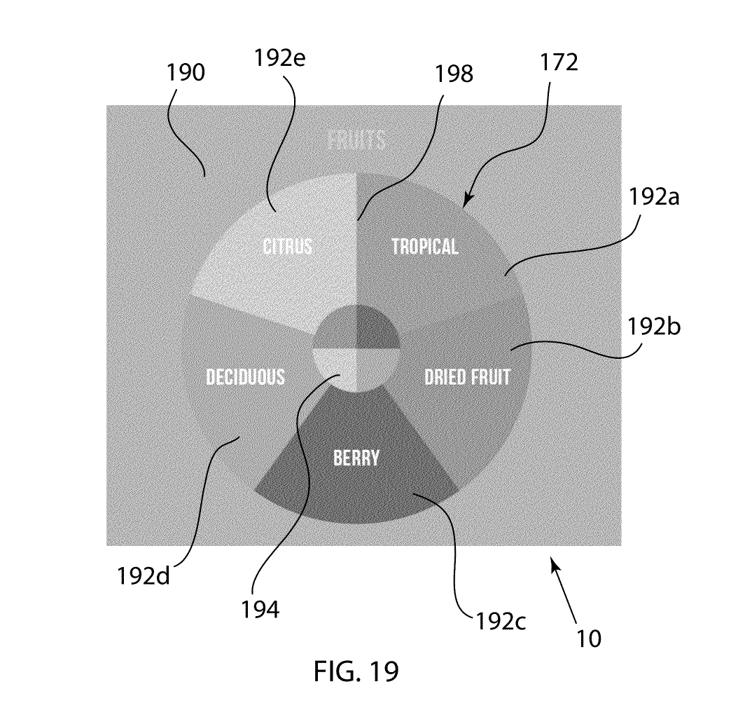

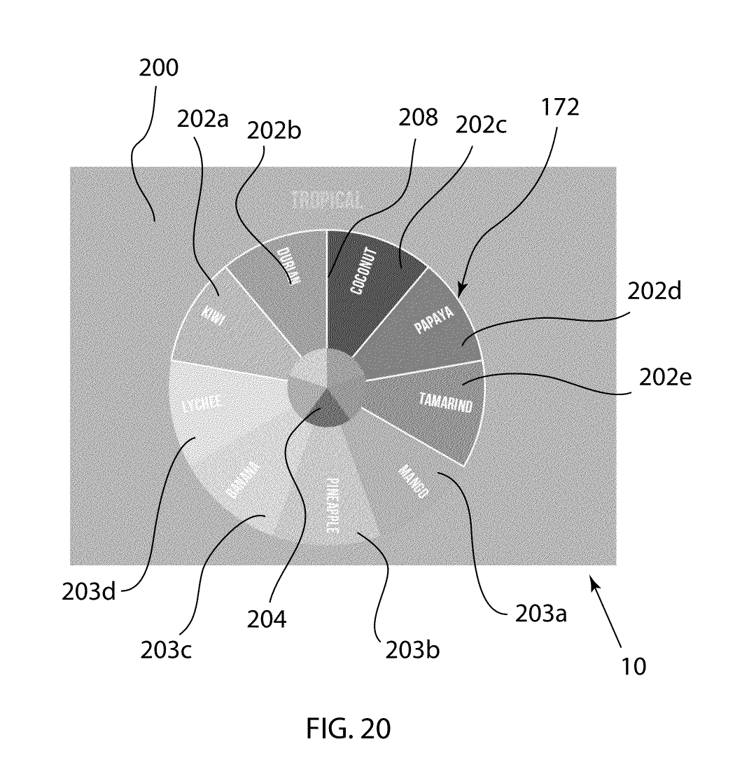

Once at least one beverage, beverage source ingredient or other product is provided to the subscriber, the subscriber may be provided access to, or otherwise begin to use an internet or web-based application 10, shown in FIGS. 1-20. In some embodiments, the application 10 may not be web-based. In this case, the data stored and hosted on a database or server running the application 10 may be downloaded along with the application to a device of the subscriber. In other embodiments, much of the data required to run the application 10 may be hosted on a server, computer, or database running at a separate location than the subscriber's device. The application 10 may be a downloadable application on a mobile device such as a phone or tablet (not shown). The application 10 may also be, for example, a web-based interface that operates within a web browser. The application 10 may be any type of computer-based application. One embodiment of the application is shown in FIGS. 1-20. The application 10 may be hosted by, or otherwise controlled by, the same entity that provides the samples to the subscriber. In other embodiments, the application 10 may be hosted or otherwise controlled by a different third party entity.

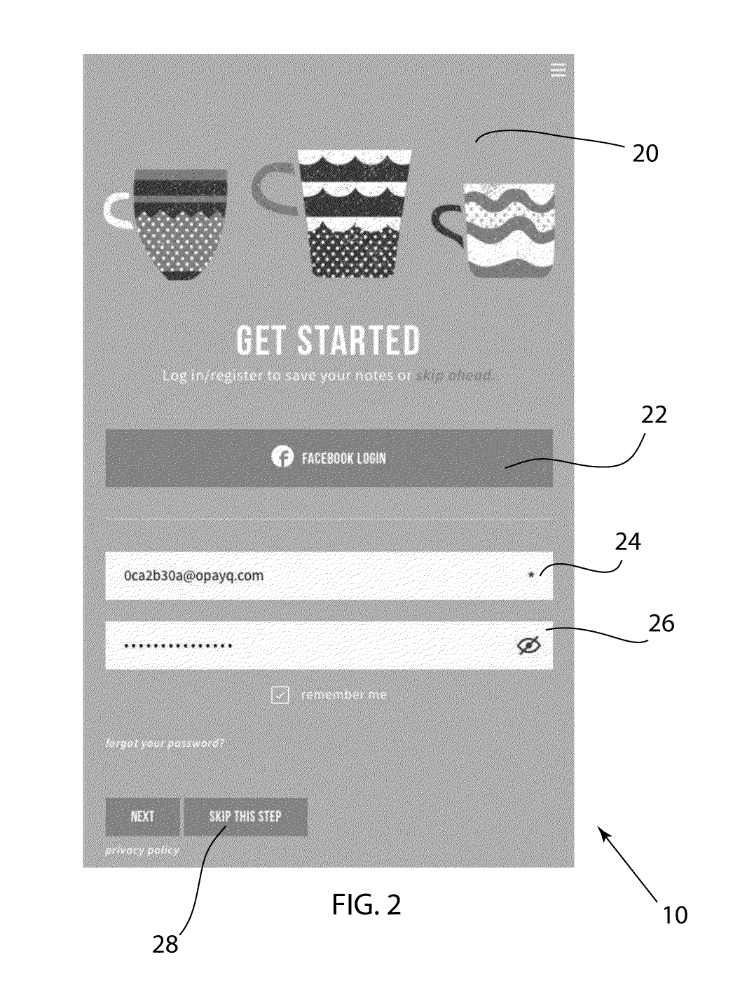

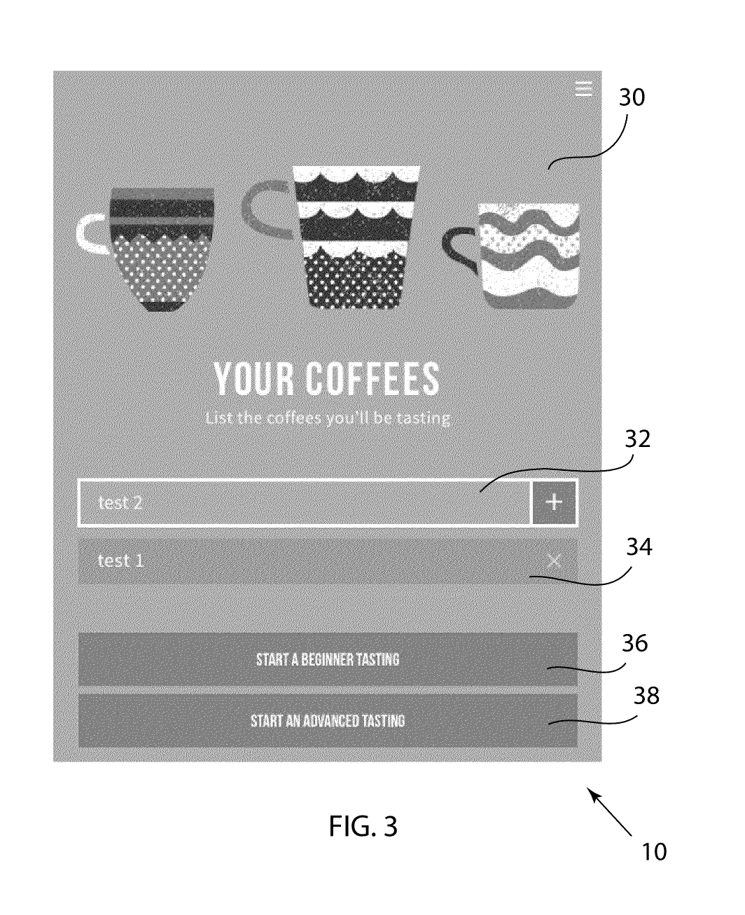

Referring to FIG. 1, the application 10 may include a welcome interface 12 when the application 10 is first opened by a user. It should be understood that “subscriber” herein refers to the person or people who purchased or subscribed to be provided samples of the beverage or other product. The “user” hereinafter refers to the person or people who are actually using the application 10. While the user may be the same person as the subscriber, there may be embodiments where the subscriber is a different person than the user. Alternatively, the application 10 may also be operable for non-subscribers that simply want to access features of the application 10 that do not require subscription. The welcome interface 12 may include several interactive buttons. In the embodiment shown, the welcome interface 12 includes a “start a tasting” button 14 which may open a coffee-entering interface 30 shown in FIG. 3. The welcome interface 12 may further include a “log in/sign up” button 16 which may open a log-in interface 20 shown in FIG. 2. The welcome interface 12 may further include a “join the conversation” button 18 for bringing a user to a forum or other community location to discuss the beverages, products, the application 10, the methods herein, and the like.

Referring to FIG. 2, the log-in interface 20 or screen is shown. The log-in interface 20 may include a social media login button 22. The log-in interface 20 may further include an option to enter an email address 24 and a password 26. A database may store the information entered and so the application 10 may be configured to remember a particular user and/or store any data collected from using the application on an account dedicated to the particular user. The log-in interface 20 also is shown including an option 28 to skip the log-in step in the event that a user does not wish to have any information stored by the application 10 to be associated with an ongoing account.

Referring to FIG. 3, the coffee-entering interface 30 is shown to start a tasting of the beverage or the resulting beverage or other product. In this stage, the coffee-entering interface 30 provides a location 32 to enter the name of the beverage, resulting beverage or other product that will be tasted. This location 32 may also be where the user may enter the identifying characteristic information, such as an alphanumeric identifying code, bar code, or the like. Once the user enters the proper information into the location 32, the application 10 may determine the identity of the beverage, beverage source ingredient, or other product being tasted. This determining may be accomplished internally within the program and, in the case that the user enters the identifying characteristic and does not yet know the identity of the beverage, beverage source ingredient, or other product, the application 10 may not yet provide this information to the user. The application 10 may further include a beginner tasting mode, accessed by a button 36, and an advanced tasting mode, accessed by a button 38. The advanced tasting mode may ask the user for more details regarding the tasting during the later interfaces described herienbelow relative to the beginner tasting mode.

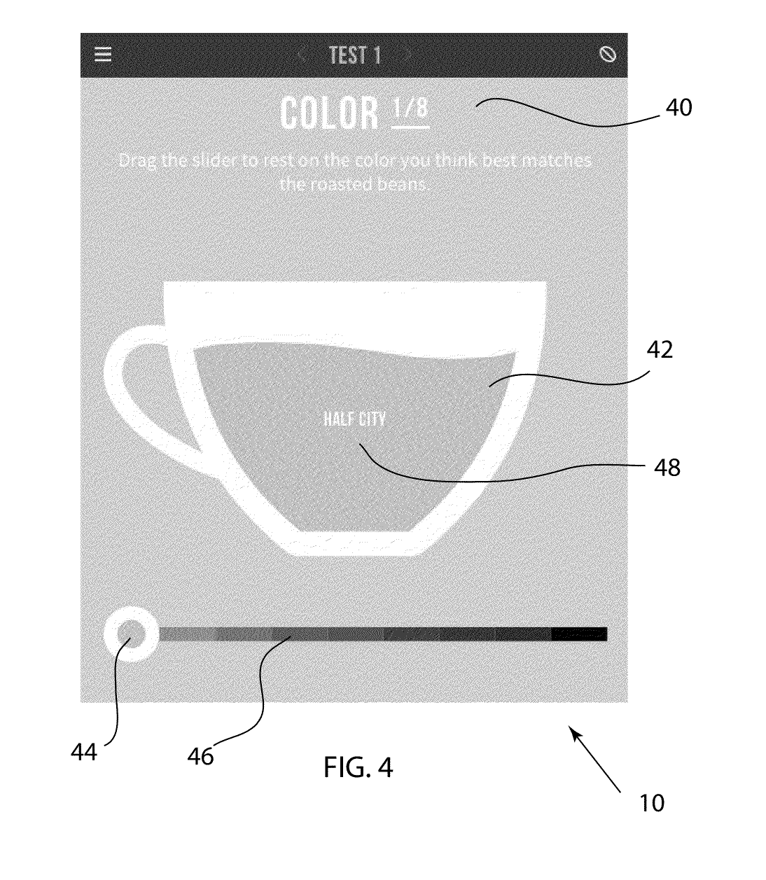

FIGS. 4-11 show embodiments of the application 10 prompting the user to enter information about the user's experience tasting the beverage, the resulting beverage, or other product. Using these interfaces, described hereinbelow, the application 10 may be configured to receive information from the user about the user's experience tasting the beverage, the resulting beverage, or other product. In particular, FIGS. 4-11 each show different steps in generating a taste profile for a user by the application 10 prompting the user to enter this information, and receiving the information by the application 10.

Referring to FIG. 4, the application 10 a color screen 40 is shown where the application 10 prompts the user to enter information pertaining to the color of the beverage, the resulting beverage, or other product. In the embodiment shown, a color slider 46 is provided having a slidable button 44. The color slider 46 includes colors ranging from light to dark as the color slider 46 is read from left to right. The color screen 40 further shows a view of the chosen color within a cup 42. Further, within the cup 42 includes a written description of a color name 48. These color names may be colors used by sommeliers or roastmasters to describe product. For example, for the case of coffee, the color names may be “half city,” “cinnamon,” “city,” “full city,” “full city+,” “Vienna,” “Italian,” “French,” and “nearly black.” These names may educate the user regarding the names used by experts in the field of tasting the given product to which the application 10 relates.

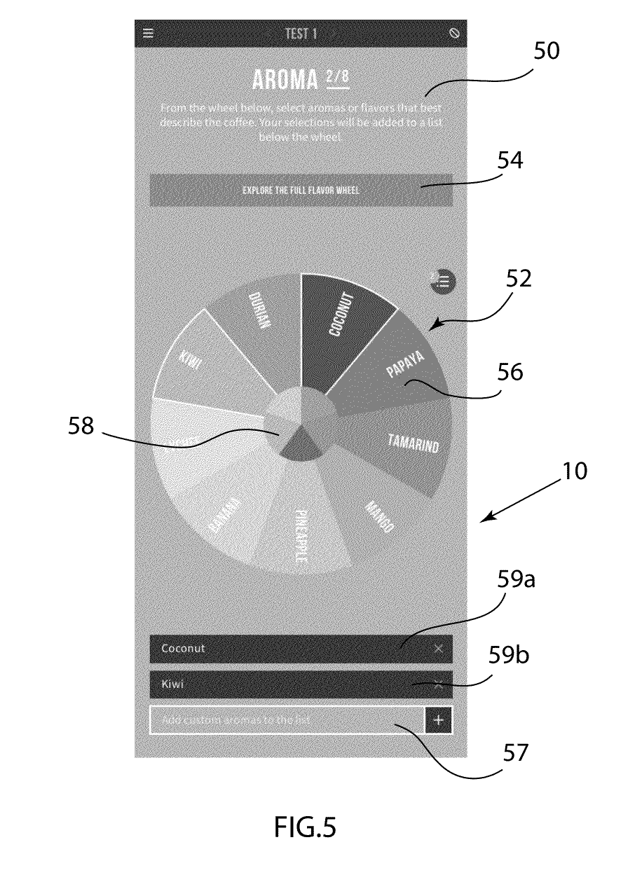

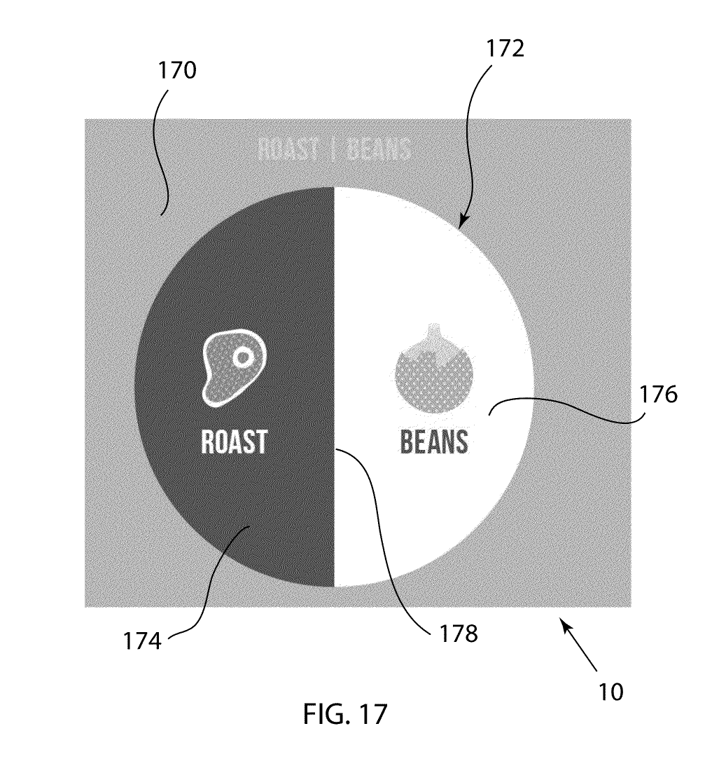

Referring now to FIG. 5, the application 10 may include an aroma screen 50 for prompting a user to enter information pertaining to the aroma of the beverage, the resulting beverage, or other product. The aroma screen 50 may include a color wheel 52. The color wheel 52 may be a graphical user interface that is configured to operate in a manner outlined hereafter with respect to FIGS. 17-20.

Referring now to FIG. 17, a first layer 178 of a pie shaped graphical user interface 172 is shown on a graphical user interface screen 170. It should be understood that the graphical user interface 172 may also be ovular, square, rectangular, or shaped like another polygon. In one embodiment, the graphical user interface may be shaped with a number of sides equal to a number of buttons located within a particular layer of the graphical user interface 172. The graphical user interface 172 may provide for additional data collection by the application 10. The graphical user interface 172 is shown having the first layer 172 displaying a first plurality of selectable pie shaped portion 174, 176. Each of the plurality of pie shaped portions 174, 176 may represent a particular flavor, aroma, or group of flavors or aromas. These may be selectable by the user. As shown in FIG. 17, these pie shaped portions 174, 176 may be half-pies.

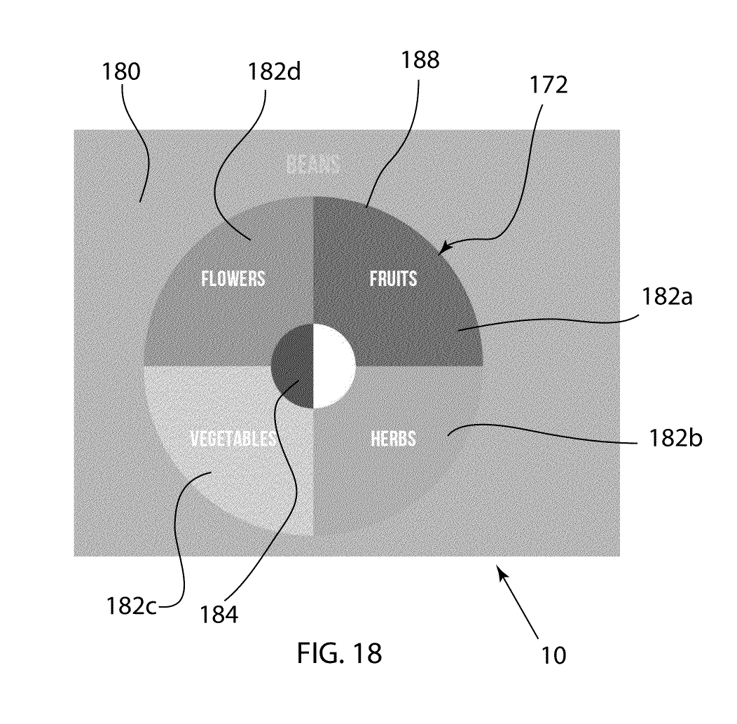

When the user selects a first of the first plurality of pie shaped portions, such as the pie shaped portion 176, the data graphical user interface 172 may then change to display a second circular layer 188, shown on a graphical user interface screen 180 in FIG. 18. The second circular layer 88 may include a second plurality of pie shaped portions 182a, 182b, 182c, 182d. The data graphical user interface 172 may display a representation 184 of the first layer 178 at a center of the second layer 188. When the user selects the representation of the first circular layer 184 at the center of the second circular layer 188, the graphical user interface 172 may revert back to displaying the first circular layer 178 shown in FIG. 17.

The first plurality of selectable of pie shaped portions 174, 176 may each be a different color to create a first color wheel. Similarly, the second plurality of selectable pie shaped portions 182a, 182b, 182c, 182d may each be a different color to create a second color wheel. The representation of the first circular layer 184 at the center of the second circular layer 188 may include the same colors as the first color wheel. Furthermore, the representation of the first circular layer 184 at the center of the second circular layer 188 may not include any of the written information found on the actual pie shaped portions 174, 176 of the first circular layer 178.

Selecting the “fruits” pie shaped portion 182a may change the graphical user interface 172 once again to a third circular layer 198, shown on a graphical user interface screen 190. The third circular layer 198 may include additional selectable pie shaped portions 192a, 192b, 192c, 192d, 192e, along with a representation of the second circular layer 194 within the center of the third circular layer 198. It should be understood that any of the previously selectable pie shaped portions 174, 182b, 182c, 182d not described in this embodiment (and those hereinafter not described) may include their own sub-interfaces in the same manner described in the present example.

Selecting the “tropical” pie shaped portion 192a may change the graphical user interface 172 one final time to a fourth circular layer 208, shown on a graphical user interface screen 200. The fourth circular layer may include additional selectable pie shaped portions 202a, 202b, 202c, 202d, 202e, each shown as selected by the user. Selection may be denoted by a white border around the selectable pie shaped portions 202a, 202b, 202c, 202d, 202e. The fourth circular layer may include selectable pie shaped portions 203a, 203b, 203c, 203d which are shown unselected.

By selecting pie shaped portions 202, 203 in this layer, the graphical user interface 172 may be configured to store data relating to these final selections. For example, in this case, the graphical user interface 172 may prompt the application to store that the user has selected “kiwi,” “durian,” “coconut,” “papaya,” and “tamarind.” It should be understood that a user may go back through the graphical user interface and continue to make selections within other selected layers of the graphical user interface. For example, a user may select the roast pie shape portion 174 on the first layer 178. This may lead to another second layer (not shown) for the selection of additional pie shaped portions. This may continue until the final subcategory of selections is made. Overall, the graphical user interface 172 may further be referred to as a “color wheel” in some embodiments.

Referring back to FIG. 5, the color wheel 52 is shown as a way to prompt a user to enter data regarding the aroma of the beverage, beverage source ingredient, or other product. The color wheel 52 may work in the manner described hereinabove with respect to the graphical user interface 172. The color wheel 52 is shown having a representation of an earlier layer 58 located in its center. The color wheel 52 is shown having a plurality of selectable pie shaped portions 56. Shown on this page, each final selection is listed as the user navigates through the color wheel at displays 59a, 59b. These displays 59a, 59b allow a user to keep track of the already-selected flavors and aromas as the user navigates through the graphical user interface or color wheel 52. Further, the aroma screen 50 includes a location 57 for a user to enter a custom aroma that may not be found within the graphical user interface or color wheel 52. Still further, a button 54 may open a graphical display of the entire color wheel 52, displaying every possible selection at the same time.

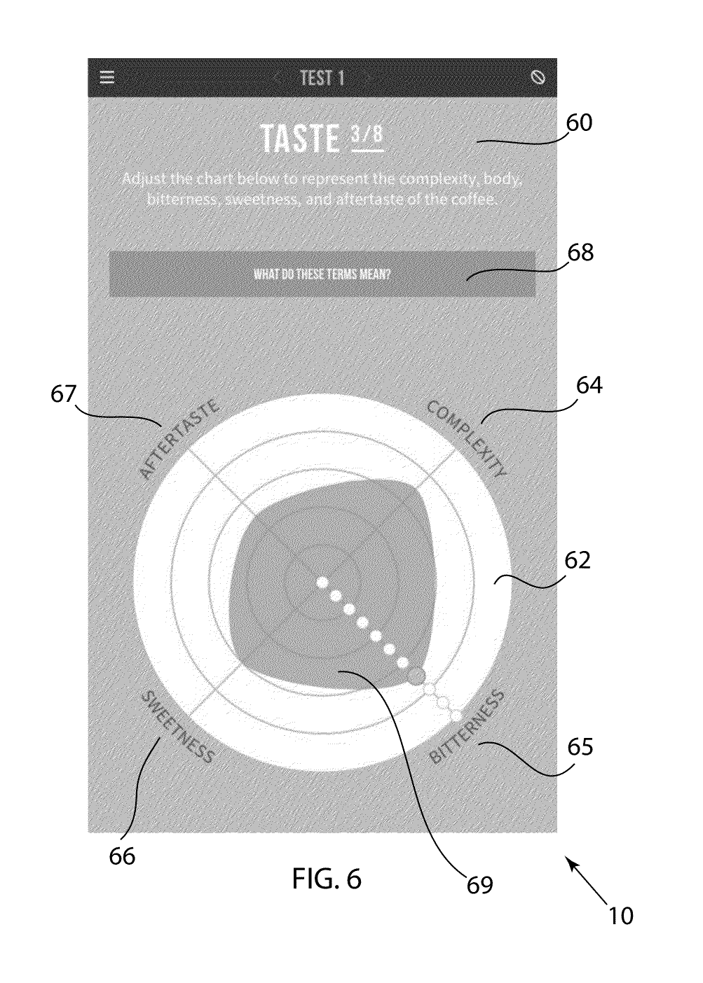

Referring now to FIG. 6, the application 10 may include a taste screen 60 for prompting a user to enter information pertaining to the taste of the beverage, the resulting beverage, or other product. The taste screen 60 may provide a radar chart 62 for prompting the user to enter information about the user's experience tasting the beverage. The radar chart may include a first radii for complexity 64, a second radii for bitterness 65, a third radii for sweetness 66, and a fourth radii for aftertaste 67. In one embodiment a fifth radii for body may also be provided (not shown). Other radar charts beyond this embodiment are contemplated, which may include radii representing at least one of a flavor, an aroma, and a taste. The radar chart 62 may operate by allowing a user to drag the outer edge of a selected area 69 outwards and inwards to select particular levels at the radii. In the embodiment shown, medium to high bitterness and complexity have been selected, while average aftertaste and slightly above average sweetness has been selected. This creates a selected area 69 representing the taste of the beverage, the resulting beverage, or other product. The taste screen 60 may further provide help to a user by explaining what each radii represents with a help button 68.

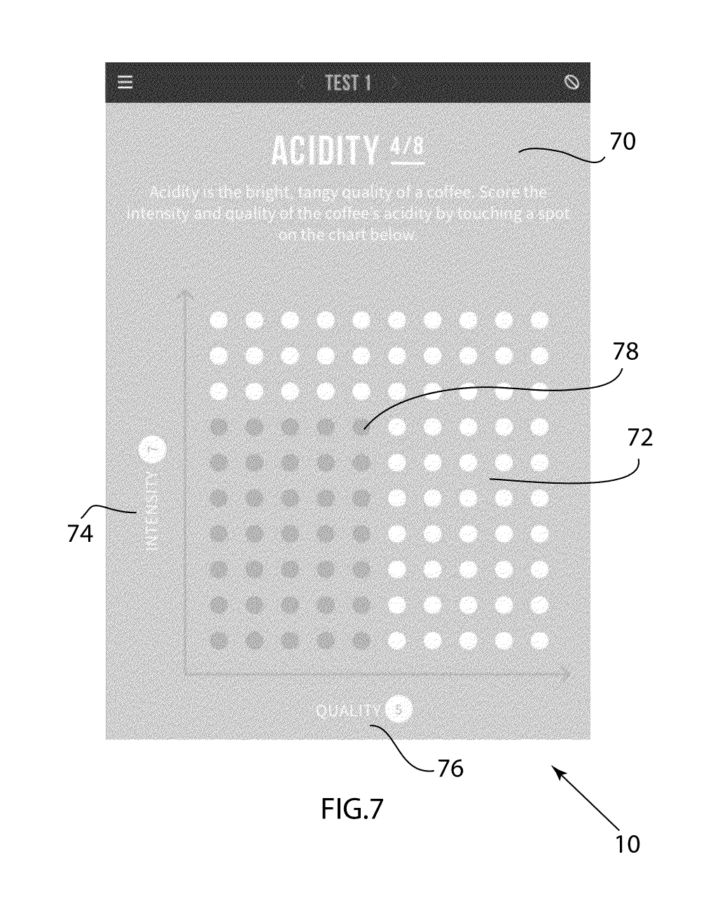

Referring now to FIG. 7, an acidity screen 70 is shown. On the acidity screen 70, the application 10 may prompt a user to enter information relative to the acidity of the beverage, resulting beverage or other product. The acidity screen 70 includes a two-axis chart 72, including an intensity y-axis 74, and a quality x-axis 76. The acidity chart 72 may comprise a plurality of dots, each dot being selectable by a user. In the embodiment shown, the user has selected a dot 78 indicating a quality of 5 and an intensity of 7. This information may be received and stored by the application 10 after being entered by the user.

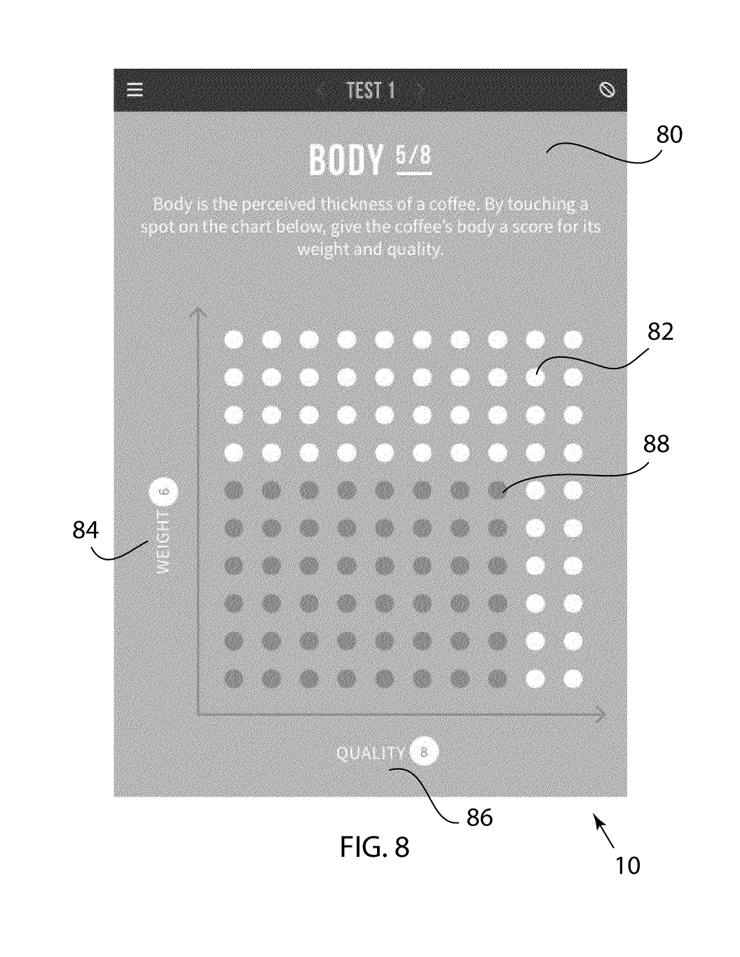

Referring now to FIG. 8, a body screen 80 is shown. On the body screen 80, the application 10 may prompt a user to enter information relative to the body of the beverage, resulting beverage or other product. The body screen 80 includes a two-axis chart 82, including a weight y-axis 84, and a quality x-axis 86. The body chart 82 may comprise a plurality of dots, each dot being selectable by a user. In the embodiment shown, the user has selected a dot 88 indicating a quality of 8 and a weight of 6. This information may be received and stored by the application 10 after being entered by the user.

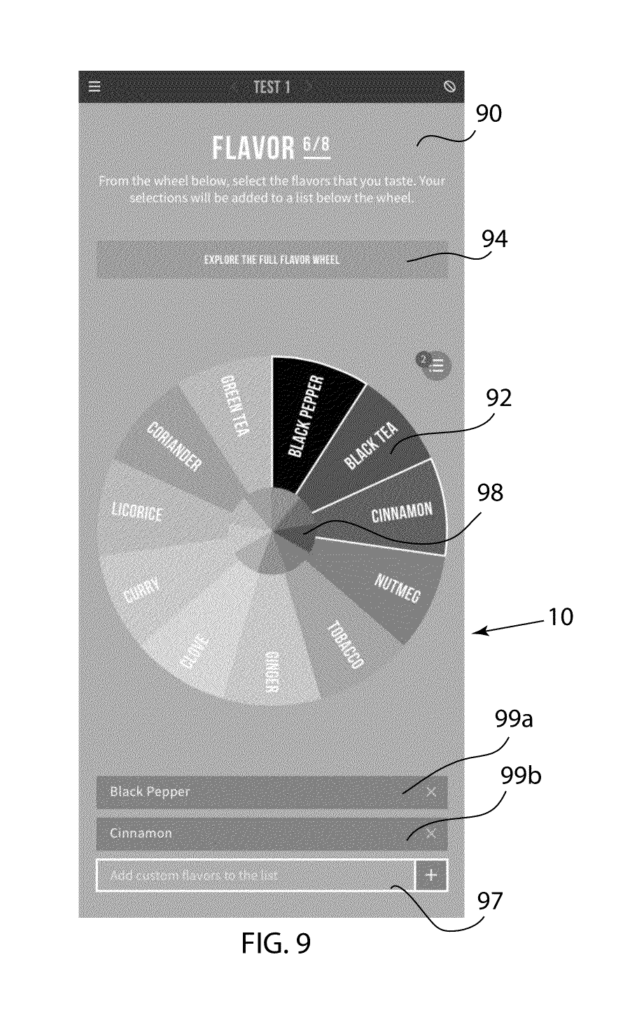

FIG. 9 displays a flavor screen 90. The flavor screen 90 includes another color wheel 92 which may function in a similar manner to the graphical user interface 172 described hereinabove. The color wheel 92 is shown as a way to prompt a user to enter data regarding the flavor of the beverage, beverage source ingredient, or other product. The color wheel 92 is shown having a representation of an earlier layer 98 located in its center. The color wheel 92 is shown having a plurality of selectable pie shaped portions 96. Shown on this page, each final selection is listed as the user navigates through the color wheel at displays 99a, 99b. These displays 99a, 99b allow a user to keep track of the already-selected flavors as the user navigates through the graphical user interface or color wheel 92. Further, the flavor screen 90 includes a location 97 for a user to enter a custom flavor that may not be found within the graphical user interface or color wheel 92. Still further, a button 94 may open a graphical display of the entire color wheel 92, displaying every possible selection at the same time.

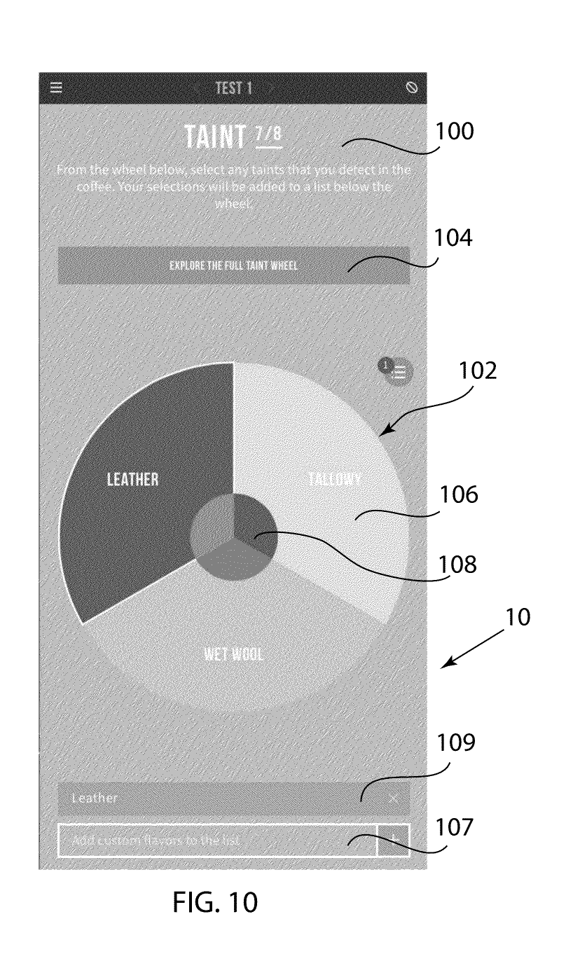

FIG. 10 displays a taint screen 100. The taint screen 100 includes another color wheel 102 which may function in a similar manner to the graphical user interface 172 described hereinabove. The color wheel 102 is shown as a way to prompt a user to enter data regarding the taint of the beverage, beverage source ingredient, or other product. The color wheel 102 is shown having a representation of an earlier layer 108 located in its center. The color wheel 102 is shown having a plurality of selectable pie shaped portions 106. Shown on this screen 100, each final selection is listed as the user navigates through the color wheel at display 109. This display 109 allows a user to keep track of the already-selected taints as the user navigates through the graphical user interface or color wheel 102. Further, the taint screen 100 includes a location 107 for a user to enter a custom taint that may not be found within the graphical user interface or color wheel 102. Still further, a button 104 may open a graphical display of the entire color wheel 102, displaying every possible selection at the same time.

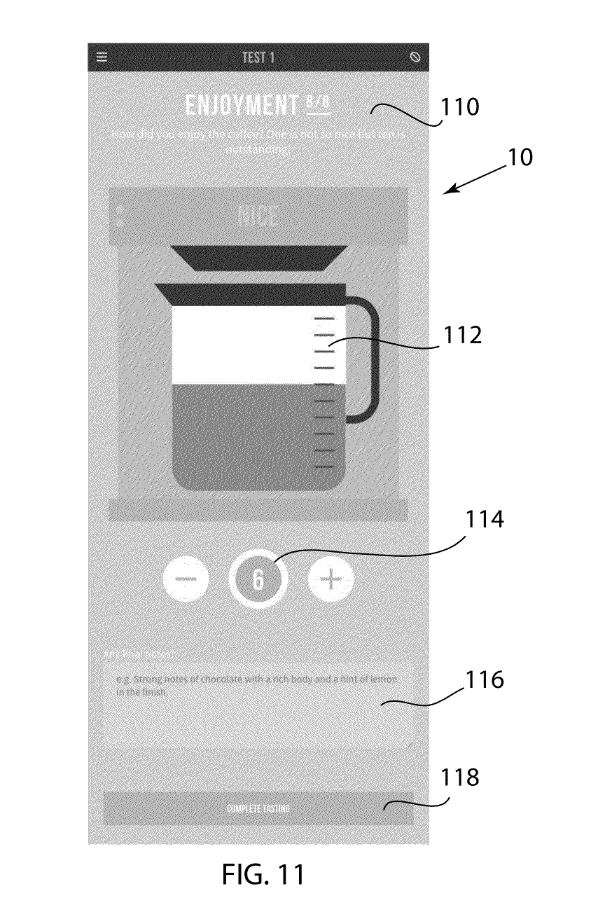

FIG. 11 depicts an enjoyment screen 110 of the application 10. On this screen a user may be prompted to enter information regarding how much the user likes the beverage, resulting beverage or other product. On the enjoyment screen 110, a graphical representation 112 of the enjoyment level is shown as a cup. A higher filled cup (by clicking on a level of the cup), may represent more enjoyment. In the embodiment shown, the cup is filled up six tenths of the way. Rather than clicking on the graphical representation 112, a user may instead click a graphical user interface +/− buttons 114. Still further, a user may enter in additional hand-written notes 116 about their enjoyment of the beverage, resulting beverage, or other product. Finally, a user may complete the tasting by clicking a “complete tasting” button 118. In other embodiments, the enjoyment screen 110 may prompt a user to enter information regarding what the user or subscriber perceives as the price of the beverage, beverage source ingredient or other product. This may indicate the perceived value the user or subscriber has of the product.

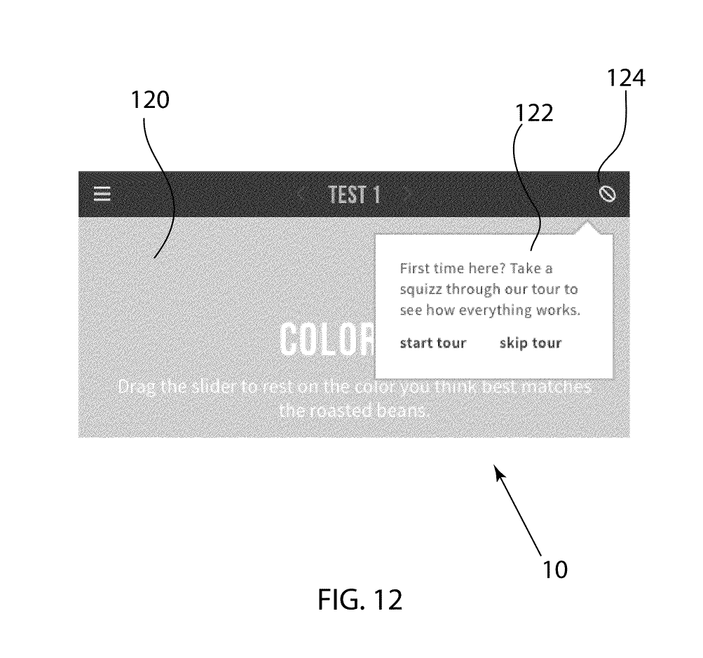

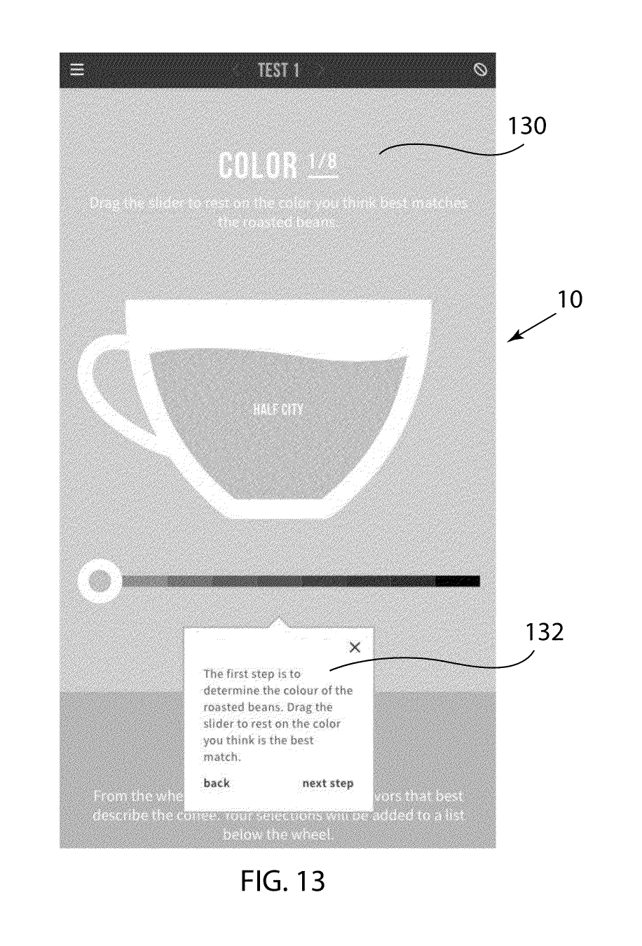

Throughout the tasting process described in FIGS. 4-11, a user may open up a guide or tour, shown in FIGS. 12-13 on a first screen 120 and a second screen 130. The guide may be accessed with a button 124 located at a top right portion of any screen of the application 10. The guide may provide pop up information 122, 132 throughout the tasting experience. This guide may provide pointers in working with the various graphical user interfaces found in the application 10, such as the color wheels, radar charts, and two-axis charts described hereinabove.

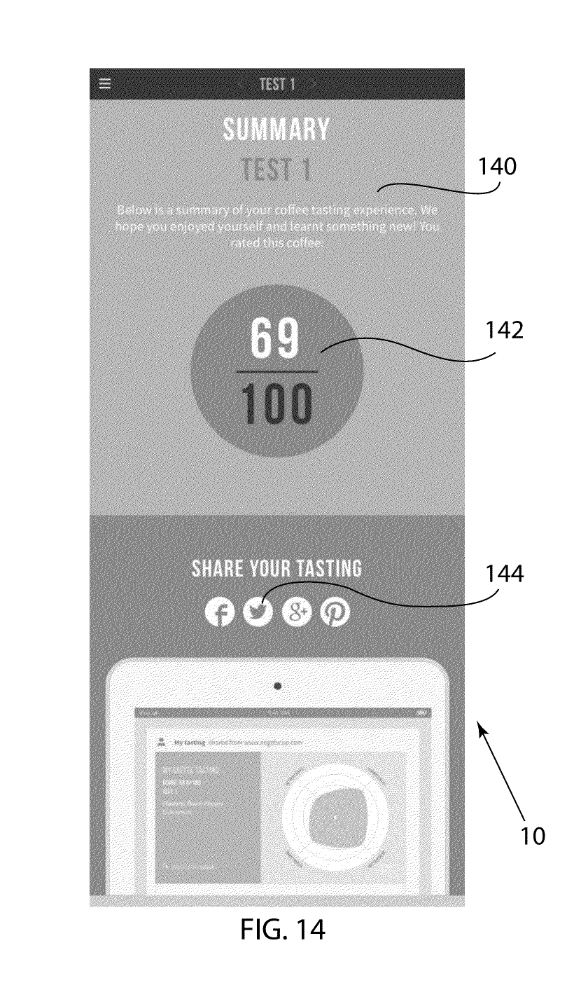

Finally, once a tasting is completed and after a user has gone through the various prompted inputs by the application 10 and the application 10 receives and/or stores information provided by the user, the application may proceed to a summary page 140, as shown in FIG. 14. At this stage, the application may compare information about the user's experience tasting the beverage, the resulting beverage or other product, with data pertaining to an expert's tasting experience tasting the beverage, resulting beverage or other product. In the case of coffee, the expert may be the roastmaster of the particular blend of coffee that was tasted by the user. In the case of whiskey or bourbon, the expert may be the distiller that distilled the particular whiskey or bourbon tasted by the user. A manufacturer, maker, or creator of the product being tasted may be an ideal candidate as an expert provided in the application 10. However, in other embodiments, experts may not be related to the product being tasted.

To obtain an expert's experience and information regarding the tasting of the beverage, the expert may use the application 10. In one embodiment, an “expert mode” may be provided, whereby, when the expert provides a specific log-in information, the application 10 determines that the user is an expert regarding the particular product being tasted, and stores the information being entered in an expert database separate from non-expert users. In other embodiments, the company that is running, hosting, and/or sending the samples, may enter the expert information by hand into a separate expert database. Thus, each product to be tasted in the application 10 may have one database or location for storing expert information related to the tasting of the product, and a second database or location for storing non-expert user information related to the tasting of the product. In one embodiment, only information from a single expert may be stored for each individual product. In other embodiments, information derived from a plurality of verified experts may be stored for each individual product. In the embodiment that a plurality of experts are stored for each product, the application 10 may aggregate the information obtained by experts and eventually use this aggregated information when comparing and displaying the user results with the expert results, as described hereinbelow. In one embodiment, three separate databases may retain information obtained by the application 10. One database or location may retain information obtained from regular users. Another database or location may retain information obtained by a source or origin company, individual or entity that made, created, or manufactured the product. Finally, a third database or location may retain information obtained by independent experts that are unrelated to the company, entity or individual that made, created, or manufactured the product.

Referring back to FIG. 14, the summary screen 140 may include an overall testing score 142 which may be a number between 0-100. In one embodiment, the testing score 142 may be a grade the user has given the beverage or product as if the user were an expert. Each user may thus be capable of generating their own score for a beverage or product. Further, the user may be able to compare their score for a beverage or product to other scores generated by the experts or other users. For example, in another embodiment, the testing score may represent the accuracy of the user's testing as compared to the expert(s) testing or to other user's testing. Accuracy may be measured in a variety of ways, for example the numeric value of the score may reflect a percentage of similarity between the user's testing and the expert testing. The summary screen 140 may further include buttons 144 for sharing the results of the testing on participating social media websites. By pressing this button, the results may automatically be output to the selected social media outlet in a manner that is clear and readable in that social media format. For example, the radar chart may be shown, with the overall score you obtained in your review of the beverage or product, further with the flavors you identified as included.

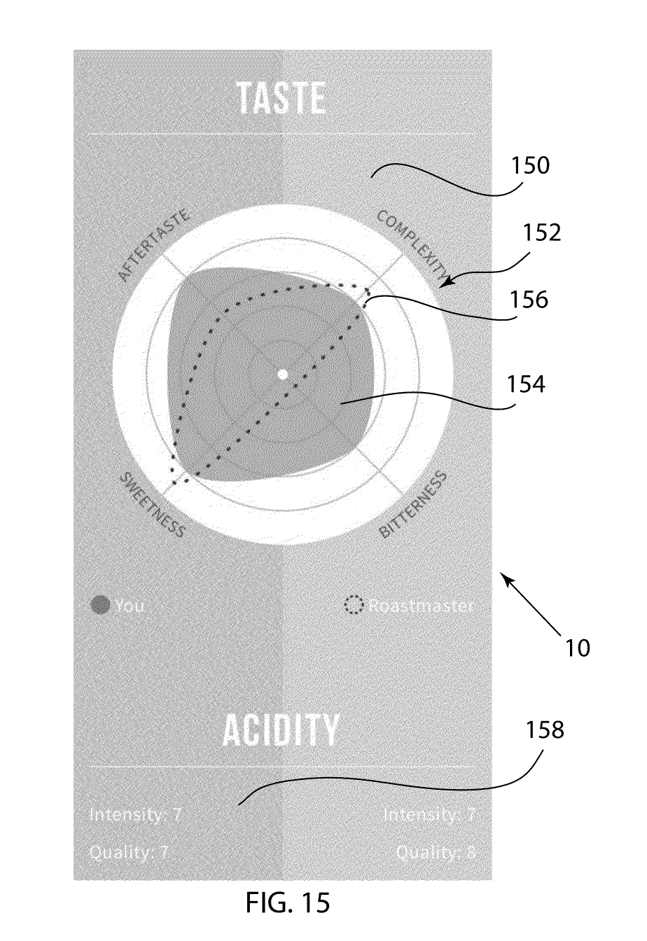

Referring to FIG. 15, the various aspects of the user's tasting experience may be compared with that of one or more experts, as shown by a second summary screen 150. This comparison may be displayed, as shown in the second summary screen 150. The second summary screen overlays an expert's results 156 with a user's results 154 on a radar chart 152. This comparison is further supplemented at the bottom of the second summary screen 150 where a numerical comparison 158 of the results of the two-axis chart for acidity is shown. Overall, the entirety of the expert results may be compared with the entirety of the user's results and displayed in a format that is easily read and understood by the user. Still further, at the summary screens 140, 150, the application 10 may be configured to display the exact identity of the beverage, beverage source ingredient, or other product, so that the user knows exactly what was just tasted, in the event that the user was using the application 10 to facilitate a blind tasting of one of the samples provided to the subscriber as described hereinabove.

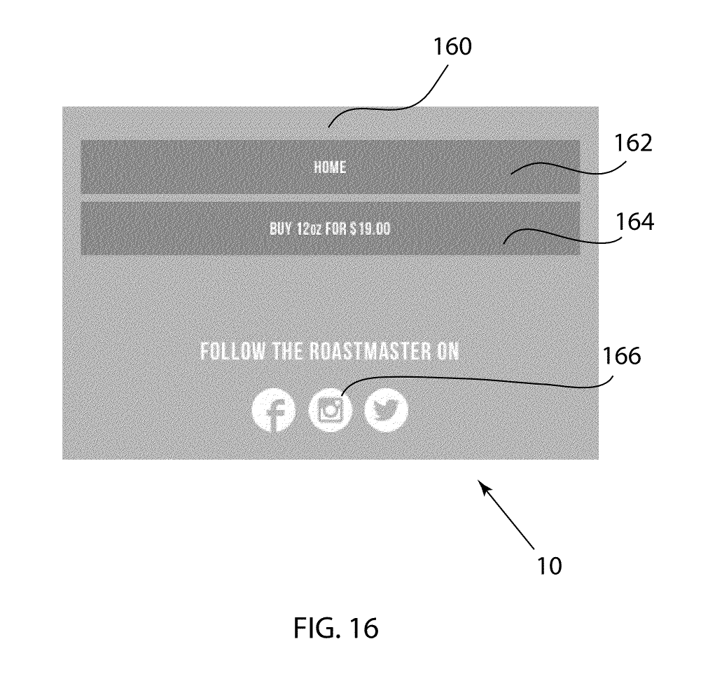

Referring now to FIG. 16, a final interface 160 is shown directing users to a website associated with an identity of the beverage tasted, by clicking a button 164. Further, this interface 160 may provide access back to the home page of the application 10 with a home button 162. The final interface 160 may further provide a user with access to the social media pages of the roastmaster, distiller, or other source of the product by providing these buttons 166.

The summary pages shown above are simply shown for exemplary purposes and are not meant to be limiting. In one additional embodiment, the application may store, in a database, data pertaining to other users tasting the beverage or the resulting beverage. The application 10 may further perform the method of aggregating the data pertaining to the other users tasting the beverage or the resulting beverage, comparing the information about the user's experience tasting the beverage or the resulting beverage with the aggregated data pertaining to the other users tasting the beverage or the resulting beverage. Thereafter, the application 10 may perform the method of displaying a comparison of the user's experience tasting the beverage or the resulting beverage with the aggregated data pertaining to the other users experience tasting the beverage or the resulting beverage. This display and comparison may occur in other embodiments of summary sections.

In another embodiment, multiple samples may be provided to a user, either simultaneously, or in succession. The company providing the samples may particularly pick or select these samples. These two selections may each have at least one taste characteristic that is discernably different than the same taste characteristic of the other. In one embodiment, two different samples may be selected and provided having values that are completely opposite on a numerical scale valuing the selected taste characteristic. For example, in one embodiment, a first sample may be provided having an extremely low acidity while a second sample may be provided having an extremely high acidity. Similarly, a first sample may be provided having an extremely low bitterness, while a second sample may be provided having an extremely high bitterness. These samples may be intended to be tasted simultaneously. The application 10 or company sending the samples may actually notify the user to do so. The application 10 may then point out the polar opposite quality of the selected taste characteristic. This may facilitate teaching a user about how to identify a particular taste characteristic of the beverage or product.

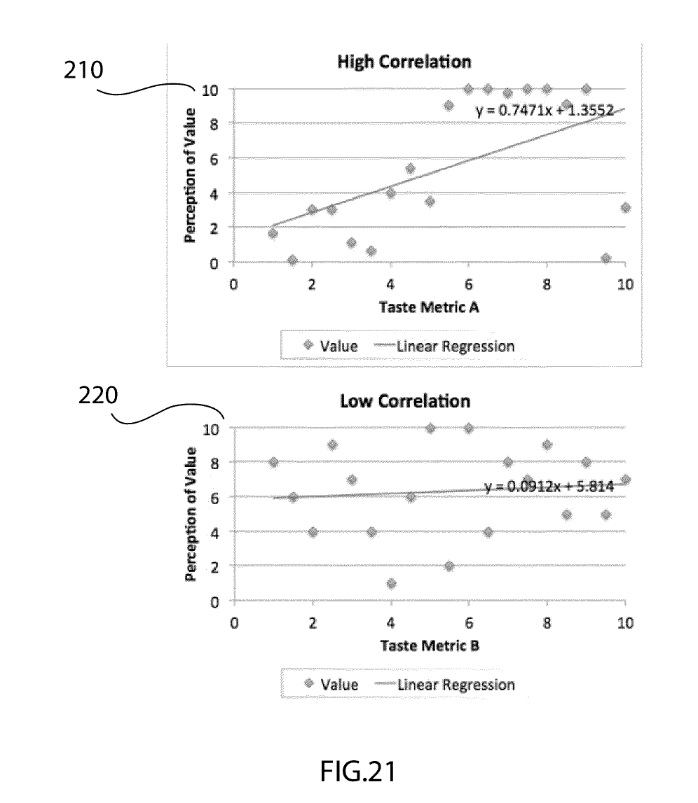

Referring now to FIG. 21, the data collected by the application 10 may be analyzed and used by the company hosting the application and sending the packaged samples to subscribers. In one embodiment, the company may select a second beverage or second source ingredient or other product, where the selecting may be based on the information from the user about the user's experience tasting the beverage or the resulting beverage or other product using the application 10. Similarly, the application 10 may provide or display advertising for a second selected beverage, where the second beverage may be selected based on information from the user about the user's experience tasting the beverage, resulting beverage or other product using the application 10.

In one embodiment, as the user tastes more beverage samples or other products, the application 10, or another application (using the data collected by the application 10) may be able to construct a profile for a user, indicating what characteristics are most correlated with a user's perception of value. A preference profile, for example, may be defined as the combination of sensory perceptions that maximize an individual's perception of value. These include, for example, color, mouthfeel, body, taste, sweetness, bitterness, sourness, complexity, balance, finish, astringency, aroma, and taints. The creation of the preference profile may be built after sending a user a plurality or many different blind samples and recording information pertaining to the tasting of those samples as described hereinabove. This recordation, of course, may continue in a continuous ongoing basis.

Statistical methods may be used to determine what influences each user's perception of value, such as linear regressions models. Referring to FIG. 21, a sample plot of a user's Perception of Value as a function of Taste Metric A is shown in a first chart 210 and a second sample plot of a user's Perception of Value as a function of a Taste Metric B is shown in a second chart 220. The data presented in the first chart 210 indicates that the user's Perception of Value does in fact vary as a function of Taste Metric A. This is because as the value of Metric A increases, so does reported Perception of value. For example, if the company sent a sample of a beverage for which Taste Metric A was established to be equal to 6, the application 10 may infer that the user's Perception of Value would be equal to 0.7471*6+1.3552, which equals 5.84. Thus, the application 10 may continue to keep data storage and chart these metrics, and infer results in this way. In contrast to the first chart 210, the second chart 220 indicates Taste Metric B has very little influence on the perception of value. When trying to estimate a user's Perception of Value, the computer system may identify Taste Metric B as an irrelevant metric and exclude it from future taste calculations or weight it minimally. Once datasets have been built, multivariate statistical analysis techniques can be used to identify relationships between the Perception of Value and more than one causative factor simultaneously. The net effect is the construction of a detailed Preference Profile on each user, which can be used as a tool to predict which beverages or other products the user would most enjoy.

The taste profile generated by the application 10 for each user can be used in a number of ways. The first and most important way the system may use the information is to help identify the best blind samples to send in the user's next tasting.

The application 10 may perform a method of optimizing which samples to send to minimize cost, for example, and maximize perception of value. For example, the application 10 may determine that a specific user loves single malt scotches in proportion to how many years the whiskey has been aged. However, aged scotches may be prohibitively expensive to ship on a regular basis, many bottles cost over $500. The system could consider the maximum cost of goods packaged into each individual box, and optimize for satisfaction across a set of four whiskies. If the maximum cost of goods for a single package is $20, the user could receive one amazing whiskey that costs $17 per sample, and then three samples that cost only $1 each. That user might report overall greater satisfaction with such an arrangement than they would with 4 whiskies of a $5 value.

By selecting samples with a taste profile that closely matches the preference profile of the user, the application 10 may continuously improve its understanding of each user. For example, if a user's ideal body is a 6/10, an algorithms of the application 10 might understand that a user's preference curve is shaped like a frown, meaning peak satisfaction is achieved somewhere in the middle of the range. But with continual testing, focusing on sending whiskeys with a body in the 4-8 range, the system will be able to determine with high confidence that a 6/10 is ideal for the user in question.

The net effect of this method performed by the application 10 may be a positive feedback loop where information about a user's preferences allows the application 10, and the overall method, to improve the user experience, which allows the application 10 to gather more information (because the customer will continue buying samples), which allows the application 10 once again to improve the user experience.

The application 10 may further be used to drive sales in an online store. For example, if an online store sells 100 bottles of whiskey, the application 10 could generate a “Match Score” indicating how well each whiskey matches the taste profile of each individual user. So if there's a 90% chance that a user would rate a whiskey an 8/10 or higher, according to the algorithms within the application 10, a store hosted by the application 10 may display a notification indicating a “90% Match”, and the application 10 may rank the results in order of how well they match.

In a further embodiment, the detailed data on what users like and an established sample distribution network may be used as a one-stop marketing shop for brands. It may be difficult for new brands to identify potential consumers and efficiently distribute samples of their products. The application 10 described herein not only identifies great potential consumers and ships samples to them, but may track data on how tastings translate directly into sales through an associated e-commerce site.

This process may include, for example: Send a user product samples; capture data on a user's taste and preference through a game or online experience; build a profile of the user that identifies the causal relationship between taste and preference; use the profile to target a marketing campaign to the most appropriate demographic; and provide the brand being marketed with data on user feedback and sell-through.

The application 10 may also use the information to suggest or drive marketing partnerships by identifying brands with attractive product offerings. As the list of subscribers of the application 10 and methods described herein grows, and the application's data on its users grows, owners of the system may be able to use this data to convince brands to provide free samples, or even pay for the taste profile data stored by the system, or to pay for their product to be included in a blind tasting.

While the markets originally targeted with the present invention may include whiskey, gin, rum, tequila, vodka, wine, beer, and coffee, it is possible that many other markets exist. The key variables that indicate an attractive market may be a) recurring purchases, b) a consumer desire for experimentation, and c) low unit costs. Wine and spirits are one example, but the same model may work for baby food, nutritional supplements, snack foods, cologne/perfume, chocolate, and tobacco.

As marketing relationships with brands deepen over time, the application 10 may include a software platform allowing brands to bid for the right to have their samples included in the customer's next shipment. Bidding prices may vary as a function of a user's Taste Profile, their propensity to purchase full bottles, geographic location, and the expected perception of value of the sample. The application 10 may allow us to place samples into our boxes in such a way that the system maximizes revenue and the perception of value from our users, while maintaining transparent pricing policies and a simple sales process.

The bidding platform of the application 10 may allow a brand representative to specify the whiskey, cost per sample, total cost of program, and a metric such as “specificity” which would correlate to a user's expected perception of value for the whiskey in question. Once those key metrics are determined, the user may be presented with a calendar where they can reserve access to cohorts of users. Prices may adjust as availability changes. The metrics driving “specificity” may remain a trade secret by the company or entity running the application 10, but pricing will be opaque in that brand representatives will be negotiating with a computer algorithm that treats everyone equally.

In another embodiment, the application 10 may record tasting notes for users or subscribers to compare answers with experts and roasters regarding how to brew each beverage, such as coffee or tea. For example, there may be many different methods of preparing coffee. For example, there may be different ratios of coffee grinds to water, different water temperatures, and different brew times. Depending on how the coffee is roasted or the natural flavor profile of the coffee, the resulting coffee may benefit from slight adjustments. The application 10 may be configured to receive detailed notes or information from experts or roasters in a database may contain detailed notes on the ideal brew method for a given beverage or coffee, that maybe shared with customers as a “brewing guide”, specific to each coffee. A graphical user interface (not shown) similar to any of the embodiments described hereinabove, may be provided to prompt a user to enter their brewing technique in to the application 10.

With data on where roasters are located and the origin countries of the coffees they ship, the application 10 may further perform the method of building a map connecting the roasters to the origins. It is often the case in coffee roasting, for example, that a roaster will obtain coffee beans from different locations in a given roast of coffee. There may also be roasts of coffee that are single roasts from a single origin or location. Connections may be drawn by the application 10 in a number of different ways depending on what the user or subscriber requests. For example, it is contemplated that the application may provide all the origins a specific roaster connects to.

The application may perform the method of showing a map or diagram of all the roasters offering coffee from a specific origin. The application may perform the method of showing a map or diagram of all the origins connected to roasters from a specific US state. The application may perform the method of showing a map or diagram of all the roasters and origins that have received a high average Acidity Quality score. The application may perform the method of showing a map or diagram of all the roasters and origins that a specific user has given high overall enjoyment scores to. The application may perform the method of showing a map or diagram of all the roasters and origins that are currently on sale. The application may perform the method of showing a map or diagram of all the roasters and origins that the user has added to a specific list, such as a list of coffees they might be interested in purchasing whole bags of. These are exemplary embodiments and other origin mapping embodiments are contemplated that follow the same general principles.

Moreover, the application 10 may perform the method of combining a digital picture with coffee tasting notes so that a user or subscriber can share their summary on social media (as described hereinabove) with a picture taken by the user or subscriber automatically attached to the share-able summary notes. This may provide an interesting way for users and/or subscribers to share coffee tasting experiences on social media. This may be accomplished by allowing users and/or subscribers to combine a picture with the automatically generated tasting note infographic already described above, into one single image in a single file format, for example, uploadable onto social media.

The application 10 may further include a “wishlist” button associated with a user's profile or account. The wishlist button may allow a user to add a beverage, beverage source ingredient, or other product to their wishlist before, during or after they are reviewing the beverage, beverage source ingredient or other product. Once added to a user's wishlist, this information may be stored by the application 10 in a database and may be accessible by the user by clicking a button to open up their wishlist page. The wishlist page may include links to allow user's or subscribers to purchase the beverage, beverage source ingredient or other product from a store provided by the application 10 or provided by the company that brewed, roasted, distilled or otherwise created the beverage, beverage source ingredient or other product.

It should be understood that references to “the application 10” may also be referring to a plurality of applications. For example, certain embodiments or functionalities described hereinabove performed by “the application 10” may actually be broken up and performed by a plurality of separately downloadable, or separately running, programs or applications. It should be understood that, in the event that “the application 10” includes a plurality of applications, these separate applications may all be connected to perform the functionalities and perform the methods described herein.

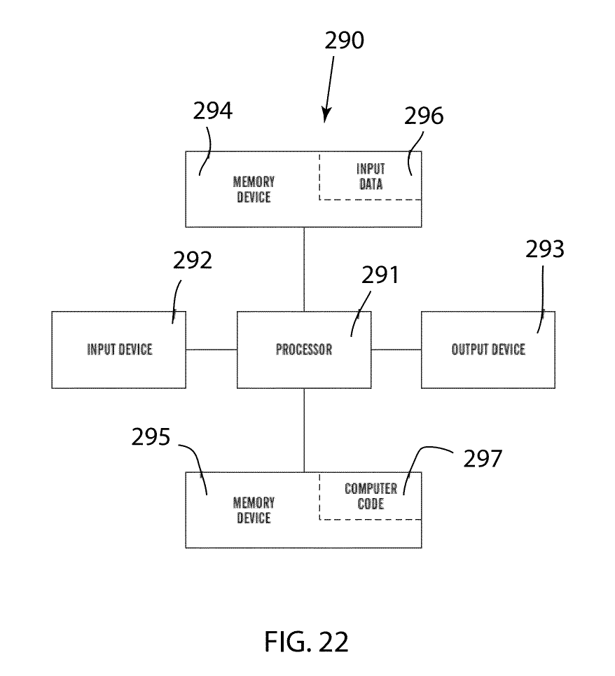

FIG. 22 illustrates a computer apparatus 290 used by the application 10 described hereinabove for performing the disclosed method and various other applications in accordance with embodiments of the present invention. The computer system 290 includes a processor 291, an input device 292 coupled to the processor 291, an output device 293 coupled to the processor 291, and memory devices 294 and 295 each coupled to the processor 291. The input device 292 may be, inter alia, a keyboard, a mouse, a camera, a touchscreen, etc. The output device 293 may be, inter alia, a printer, a plotter, a computer screen, a magnetic tape, a removable hard disk, a floppy disk, etc. The memory devices 294 and 295 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 295 includes a computer code 297. The computer code 297 includes algorithms (e.g., the algorithms of FIGS. 2-5) for providing a means for performing the methods and applications described herein. The processor 291 executes the computer code 297. The memory device 294 includes input data 296. The input data 296 includes input required by the computer code 297. The output device 293 displays output from the computer code 297. Either or both memory devices 294 and 295 (or one or more additional memory devices not shown in FIG. 22) may include the algorithms described hereinabove and may be used as a computer usable medium (or a computer readable medium or a program storage device) having a computer readable program code embodied therein and/or having other data stored therein, wherein the computer readable program code includes the computer code 297. Generally, a computer program product (or, alternatively, an article of manufacture) of the computer system 290 may include the computer usable medium (or the program storage device).

Still yet, any of the components of the present invention could be created, integrated, hosted, maintained, deployed, managed, serviced, etc. by a service supplier who offers to provide a means for performing the methods and applications described herein. Thus the present invention discloses a process for deploying, creating, integrating, hosting, maintaining, and/or integrating computing infrastructure, including integrating computer-readable code into the computer system 290, wherein the code in combination with the computer system 290 is capable of performing the methods and applications described herein. In another embodiment, the invention provides a business method that performs the process steps of the invention on a subscription, advertising, and/or fee basis. That is, a service supplier, such as a Solution Integrator, could offer to provide the methods and applications described herein. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 22 shows the computer system 290 as a particular configuration of hardware and software, any configuration of hardware and software, as would be known to a person of ordinary skill in the art, may be utilized for the purposes stated supra in conjunction with the particular computer system 290 of FIG. 22. For example, the memory devices 294 and 295 may be portions of a single memory device rather than separate memory devices.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms. The terms “first” and “second” are used to distinguish elements and are not used to denote a particular order.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

I claim:

1. A method comprising:
providing at least one sample of a beverage or beverage source ingredient in a package to a subscriber, wherein an identity of the beverage or beverage source ingredient is not provided, wherein the at least one sample includes an identifying characteristic, wherein the identifying characteristic does not provide any information about the identity of the beverage or beverage source ingredient to the subscriber; and
providing a computer application, wherein the application performs the steps of:
receiving the identifying characteristic;
prompting the user to enter information about the user's experience tasting the beverage or a resulting beverage that derives from the beverage or beverage source ingredient;
receiving information from the user about the user's experience tasting the beverage or the resulting beverage;
determining, using the identifying characteristic, the identity of the beverage or beverage source ingredient;
receiving information from an expert regarding the expert's experience tasting the beverage or the resulting beverage;
storing data pertaining to the expert's experience tasting the beverage or the resulting beverage;
comparing the information about the user's experience tasting the beverage or the resulting beverage with the data pertaining to the expert's experience tasting the beverage or the resulting beverage; and
displaying a comparison of the user's experience tasting the beverage or the resulting beverage with the expert's experience tasting the beverage or the resulting beverage.

2. The method of claim 1, wherein the expert is a roastmaster and wherein the beverage or beverage source ingredient is coffee beans and the resulting beverage is coffee.

3. The method of claim 1, further comprising displaying the identity of the beverage or beverage source ingredient after the receiving information from the user about the user's experience tasting the beverage or resulting beverage.

4. The method of claim 1, wherein the displaying the comparison of the user's experience tasting the beverage or the resulting beverage with the expert's experience tasting the beverage or the resulting beverage includes overlaying a graphical representation of the expert's experience tasting the beverage or the resulting beverage over a graphical representation of the user's experience tasting the beverage or the resulting beverage.

5. The method of claim 1, further comprising:
storing, in the database, data pertaining to other users tasting the beverage or the resulting beverage;
aggregating the data pertaining to the other users tasting the beverage or the resulting beverage;
comparing the information about the user's experience tasting the beverage or the resulting beverage with the aggregated data pertaining to the other users tasting the beverage or the resulting beverage; and
displaying a comparison of the user's experience tasting the beverage or the resulting beverage with the aggregated data pertaining to the other users experience tasting the beverage or the resulting beverage.

6. The method of claim 1, further comprising providing a second sample of a second beverage or second beverage source ingredient in a second package to the subscriber, wherein an identity of the second beverage or second beverage source ingredient is not provided, wherein the second sample includes a second identifying characteristic, wherein the second identifying characteristic does not provide any information about the identity of the second beverage or second beverage source ingredient to the subscriber;
providing a computer application, wherein the application performs the steps of:
prompting the user to enter information about the user's experience tasting a first characteristic of the beverage or resulting beverage;
receiving information from the user about the user's experience tasting the first characteristic of the beverage or resulting beverage;
storing data pertaining to a first expert's experience tasting the first characteristic of the beverage or resulting beverage;
receiving the second identifying characteristic;
determining, using the second identifying characteristic, the identity of the second beverage or second beverage source ingredient;
prompting the user to enter information about the user's experience tasting the first characteristic of the second beverage or a second resulting beverage that derives from the second beverage or beverage source ingredient;
receiving information from the user about the user's experience tasting the first characteristic of the second beverage or the second resulting beverage;
storing data pertaining to the first expert's experience or a second expert's experience tasting the first characteristic of the second beverage or the second resulting beverage, wherein the first expert's experience tasting the first characteristic of the beverage or the resulting beverage has a discernible difference compared with the first or second expert's experience tasting the first characteristic of the second beverage or the second resulting beverage.

7. The method of claim 6, wherein the providing the second sample of the second beverage or second beverage source ingredient in the second package to the subscriber is performed simultaneously to the providing the sample of the beverage or beverage source ingredient in the first package to the subscriber.

8. The method of claim 1, wherein the subscriber and the user is the same person.

9. The method of claim 1, wherein the application further performs the step of:
providing a graphical user interface, the graphical user interface displaying a first layer comprising of a first plurality selectable of pie shaped portions,
wherein, when the user selects a first of the first plurality of pie shaped portions, the graphical user interface displays a second layer comprising a second plurality of pie shaped portions and further the graphical user interface displays a representation of the first layer at a center of the second layer,
wherein, when the user selects the representation of the first layer at the center of the second layer, the graphical user interface reverts back to displaying the first layer,
wherein, when the user selects a first of the second plurality of pie shaped portions, the data graphical user interface stores data relating to the selection of the first of the second plurality of pie shaped portions.

10. The method of claim 9, wherein the first layer is circular and wherein the second layer is circular, and wherein the first plurality selectable of pie shaped portions are each a different color to create a first color wheel, and wherein the second plurality of selectable pie shaped portions are each a different color to create a second color wheel, and wherein the representation of the first layer at the center of the second layer includes the same colors as the first color wheel.

11. The method of claim 1, further comprising:
selecting a second beverage or second source ingredient, wherein the selecting is based on the information from the user about the user's experience tasting the beverage or the resulting beverage; and
providing at least one sample of the second beverage or second beverage source ingredient in a second package to the subscriber, wherein an identity of the beverage or beverage source ingredient is not provided, wherein the at least one sample of the second beverage or second beverage source includes a second identifying characteristic, wherein the second identifying characteristic does not provide any information about the identity of the second beverage or second beverage source ingredient to the subscriber.

12. The method of claim 1, wherein the application further performs the steps of:
selecting a second beverage or second source ingredient, wherein the selecting is based on the information from the user about the user's experience tasting the beverage or the resulting beverage; and
displaying advertising for a second beverage or second source ingredient.

13. The method of claim 1, wherein the prompting the user to enter information about the user's experience tasting the beverage or a resulting beverage that derives from the beverage or beverage source ingredient includes prompting the user to enter how much the user likes the beverage or the resulting beverage.

14. The method of claim 6, wherein the steps of:
prompting the user to enter information about the user's experience tasting a first characteristic of the beverage or resulting beverage,
receiving information from the user about the user's experience tasting the first characteristic of the beverage or resulting beverage,
prompting the user to enter information about the user's experience tasting the first characteristic of the second beverage or a second resulting beverage that derives from the second beverage or beverage source ingredient, and
receiving information from the user about the user's experience tasting the first characteristic of the second beverage or the second resulting beverage,
are performed at least substantially simultaneously.

15. The method of claim 1, wherein the step of prompting the user to enter information about the user's experience tasting the beverage or a resulting beverage that derives from the beverage or beverage source ingredient includes providing a color slider that presents color names corresponding to a color of the beverage or the resulting beverage as perceived by the user.

16. The method of claim 1, wherein the step of prompting the user to enter information about the user's experience tasting the beverage or a resulting beverage that derives from the beverage or beverage source ingredient includes providing a radar chart, wherein each radii represents at least one of a flavor, an aroma, and a taste.

17. The method of claim 16, wherein the radar chart includes a first radii for complexity, a second radii for aftertaste, a third radii for bitterness, a fourth radii for sweetness, and a fifth radii for body.

18. The method of claim 1, wherein the computer application includes a beginner tasting mode and an advanced tasting mode, wherein the prompting the user to enter information about the user's experience tasting the beverage or a resulting beverage that derives from the beverage or beverage source ingredient includes prompting the user to enter in more detailed information in the advanced tasting mode compared to the beginner tasting mode.

19. A method comprising:
providing at least one sample of a beverage or beverage source ingredient in a package to a subscriber, wherein an identity of the beverage or beverage source ingredient is not provided, wherein the at least one sample includes an identifying characteristic, wherein the identifying characteristic does not provide any information about the identity of the beverage or beverage source ingredient to the subscriber; and
providing a computer application, wherein the application performs the steps of:
receiving the identifying characteristic;
determining, using the identifying characteristic, the identity of the beverage or beverage source ingredient;
prompting the user to enter information about the user's experience tasting the beverage or a resulting beverage that derives from the beverage or beverage source ingredient;
receiving information from the user about the user's experience tasting the beverage or the resulting beverage;
storing, in a database, data pertaining to other users tasting the beverage or the resulting beverage;
aggregating the data pertaining to the other users tasting the beverage or the resulting beverage;
comparing the information about the user's experience tasting the beverage or the resulting beverage with the aggregated data pertaining to the other users tasting the beverage or the resulting beverage; and
displaying a comparison of the user's experience tasting the beverage or the resulting beverage with the aggregated data pertaining to the other users experience tasting the beverage or the resulting beverage.

20. A method comprising:
providing a first sample of a first beverage or first beverage source ingredient in a first package and a second sample of a second beverage or second beverage source ingredient in a second package to a subscriber, wherein the identity of the first beverage or first beverage source ingredient and the second beverage or second beverage source ingredient are not provided, wherein the first sample includes a first identifying characteristic, wherein the first identifying characteristic does not provide any information about the identity of the first beverage or first beverage source ingredient to the subscriber, wherein the second sample includes a second identifying characteristic, wherein the second identifying characteristic does not provide any information about the identity of the second beverage or second beverage source ingredient to the subscriber; and
providing a computer application, wherein the application performs the steps of:
receiving the first identifying characteristic;
determining, using the first identifying characteristic, the identity of the first beverage or first beverage source ingredient;
prompting the user to enter information about the user's experience tasting a first characteristic of the first beverage or a first resulting beverage derived from the first beverage source ingredient;
receiving information from the user about the user's experience tasting the first characteristic of the first beverage or the first resulting beverage;
storing data pertaining to a first expert's experience tasting the first characteristic of the first beverage or the first resulting beverage;
receiving the second identifying characteristic;
determining, using the second identifying characteristic, the identity of the second beverage or second beverage source ingredient;
prompting the user to enter information about the user's experience tasting the first characteristic of the second beverage or a second resulting beverage derived from the second beverage source ingredient;
receiving information from the user about the user's experience tasting the first characteristic of the second beverage or the second resulting beverage; and
storing data pertaining to the first expert's experience or a second expert's experience tasting the first characteristic of the second beverage or the second resulting beverage, wherein the first expert's experience tasting the first characteristic of the first beverage or the first resulting beverage has a discernible difference compared with the first or second expert's experience tasting the first characteristic of the second beverage or the second resulting beverage.
